(19) United States
(12) Patent Application Publication
(10) Pub. No.: US 2007/0080171 A1
(43) Pub. Date: Apr. 12, 2007

(54) Method and apparatus for applying a foam layer

(75) Inventors: David C Dressel, Houston, TX (US); Peter N Longtin, League City, TX (US)

Correspondence Address: CONLEY ROSE, P.C., P. O. BOX 3267, HOUSTON, TX, 77253-3267, US

(73) Assignee: BASF Corporation, Wyandotte, MI (US)

(21) Appl. No.: 10/542,899

(22) PCT Filed: Jan. 21, 2004
(86) PCT No.: PCT/US04/01533

§ 371 Date: Jan. 17, 2006

Related U.S. Application Data
(60) Provisional application No. 60/441,546, filed on Jan. 21, 2003.

(51) Int. Cl. B67D 5/60

(52) U.S. Cl. 222/145.6

(57) ABSTRACT

A system for applying a layer of foam comprises a first fluid supply supplying a first stream of a first fluid in a first supply line, a first flow divider splitting said first stream into primary and secondary streams, a second fluid supply supplying a second fluid in a second supply line, a second flow divider splitting said second stream into primary and secondary streams, a first mix head combining the primary stream of the first fluid with the primary stream of the second fluid, and a second mix head combining the secondary stream of the first fluid with the secondary stream of the second fluid.

The use of froth or pour foams in manufacturing is significant and continues to increase. Polymeric foams, such as isocyanate-, urethane- and urea-based blown foams in particular are increasingly used as insulating and structural materials. These foams are rigid when cured and are commonly used with one or more additional layers of material to form a composite object having superior mechanical and/or insulating properties. Examples of foam applications include structural panels for residential construction, boat hulls, garage and refrigerator door construction, metal building panels, walk-in cooler-panels, and the like.

Polymer foams typically comprise a resin and a blowing agent. These may or may not be kept separate prior to blowing. It is common for the blowing agent to be mixed into one of the chemical components of the resin. When it is desired to form a foam, the components are mixed and allowed to come to ambient pressure. The blowing agent expands and forms a gas, either as a result of a reduction in pressure, and/or as a result of chemical reaction with the resin. Somewhat more slowly, the resin polymerizes so that rigid bubbles are ultimately formed.

In the applications in which these foams are used it is commonly desirable to apply a substantially uniform layer of the foam across a substrate or surface. Because these foams are frothy when produced, however, they do not typically flow well enough to self-level.

If the foam is being applied to a large area, such as a panel, it is common to provide a belt, which transports the panel laterally, and a nozzle, which applies the foam to the moving panel. In order to provide a more uniform layer of foam on the panel, the nozzle may oscillate in a direction transverse to the direction of movement of the panel, moving back and forth between the edges of the panel. Because the rate of oscillation of the nozzle must be a function of the belt speed, however, it is difficult to achieve a sufficiently uniform layer in this manner at commercial speeds, and resultant physical properties vary, within there patterns and; as a result, in the final composite panel. FIG. 1, shows the zig-zag foam pattern that is produced with this technique and illustrates the nature of this problem.

Attempts have been made to provide a nozzle or applicator having multiple openings, in order to provide a more even flow of froth onto the substrate. These have proved unsatisfactory, however, because one or more of the openings tend to become clogged, which tends to increase the flow through the remaining openings, resulting in an uncontrolled and uneven flow distribution. Hence, it remains desirable to provide an apparatus that can provide a controlled, even distribution of froth or normal pour foams (i.e. with water and/or pentane and/or HFC-245fa blowing agent) foam across a surface or substrate. The desired apparatus is capable of operating at practical commercial rates and of maintaining a consistent foam delivery and performance over prolonged periods of use.

### SUMMARY OF THE INVENTION

The present invention includes a method and apparatus for applying controlled, even distribution of froth foam across a surface or substrate. The present apparatus is capable of operating at practical commercial rates and of maintaining a consistent performance over prolonged periods of use. In one embodiment, the present invention includes a foam application system that comprises at least one output stream, at least one flow divider, and at least two applicator heads. The flow divider is preferably a proportional flow divider and can be any suitable device such as are known in the art, including but not limited to rotary gear flow dividers, screw-driven flow dividers, spool flow dividers, and the like.

In a preferred embodiment, each of at least two output streams is passed through a flow divider, and the resulting split streams are recombined as mixed streams having desired compositions. The relative volumes of split streams, and thus of the combined streams can be controlled. The result is that a single foam generating system (pumps, etc.) can be used to produce multiple application streams having virtually identical compositions and, if desired, identical flow rates. The flow dividers of the present invention can also be used to provide a desired pressure drop in instances.

### BRIEF DESCRIPTION OF THE DRAWINGS

For a more detailed understanding of the invention, reference is made to the accompanying drawings, wherein:

FIG. 1 illustrates a disadvantage of the prior art; and

FIG. 2 is a schematic representation of a system in accordance with one embodiment of the invention.

### DETAILED DESCRIPTION OF THE PREFERRED EMBODIMENTS

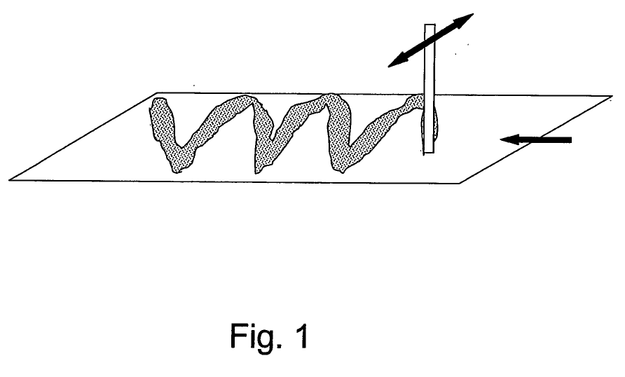

Referring initially to FIG. 1, a system constructed in accordance with a first embodiment of the invention includes a chemical supply 10, a first flow divider 20, a second flow divider 30, and a plurality of mix heads 50. In a preferred embodiment, the present system is used in conjunction with a polyurethane, and/or polyisocyanate, and/or polyurea foam system. As is known in the art, the chemical mixtures that form these foams typically comprise an “A side” and a “B side.” A blowing agent, such as HCFC-22, HFC-134a,, HFC-245fa, hydrocarbon, water or the like, is typically included in the B side. Because the chemical components of the foam react on contact, the A side and the B side are kept separate until it is desired to form and apply the foam. The flow dividers divide the A and B (separately) chemical streams and keep them separate before the mix head. Hence, chemical supply 10 includes first and second supply tanks 13, 14, respectively, from which the A and B chemicals flow into first and second supply lines 12 and 14, respectively. Chemical supply 10 preferably includes pumps and controls (not shown) such that the chemicals are pumped into supply lines 12 and 14 at a predetermined desired proportion.

First supply line 12 flows into first flow divider 20 and second supply line 14 flows into second flow divider 30. Each flow divider splits the incoming fluid stream into two or more output streams. Accordingly, first flow divider 20 splits the stream in line 12 into split streams 22, 24, respectively, and flow divider 30 splits the stream in line 14 into split streams 32, 34, respectively. Each split streams is directed to one of a plurality of mix heads. In a preferred embodiment, each mix head receives a stream from each flow divider. The chemicals provided via the split streams are mixed within each mix head and flow out through an application nozzle 52.

Because lines 12 and 14 preferably contain the chemical components in a predetermined proportion and flow dividers 20, 30 can be set such that they each divide their respective streams into the same fractions, the relative volumes of the split streams can be controlled. Thus, if the ratio of the volume of stream 24 to stream 22 is the same as the ratio of the volume of stream 34 to stream 32, streams 22 and 32 and streams 24 and 34 can be combined to form mixed streams having the same desired composition. Hence, the present system allows the flow output from a single stream to be provided as a plurality of equivalent streams. Furthermore, the volume output of each mixed stream can be controlled, so it is not necessary to provide identical fluid flow rates at each mix head 50.

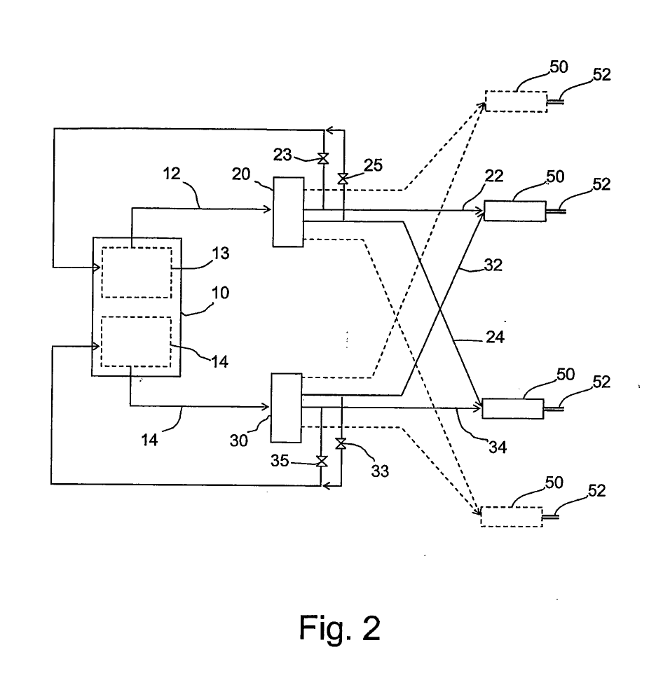

It will be understood that, each flow divider could divide the incoming fluid stream into more than two output streams, if desired, as shown in phantom. These split streams could be directed to additional mix heads, also shown in phantom. Similarly, while FIG. 2 illustrates a system with two flow dividers 20, 30, more than two flow dividers could be used in parallel so as to provide equal fluid flow to multiple application nozzles. Likewise, flow dividers could be provided in series. For example flow dividers 20, 30 could each output two streams, which in turn are fed to four additional flow dividers downstream. The output of these four flow dividers can in turn be used in four mix heads 50 partially shown in phantom FIG. 1.

In some preferred embodiments, a recycle line may be provided to optionally recycle fluid from the output of at least one of the flow dividers back to the reservoir or tank containing that fluid. Flow through these recycle lines is preferably each controlled by a corresponding valve 23, 25, 33, 35. This is advantageous on startup, when pressure in the system has not attained its operational level, as the fluid can be recycled through the supply tank until the fluid is warm and/or sufficient pressure is present in the system to provide adequate mixing in the mix heads.

In addition, each flow divider can be configured to provide a desired pressure drop. In systems where the pump pressure available at the outlet of chemical supply 10 is greater than desired, flow dividers 20, 30 can be used to bring the fluid pressure down to a desired level, without the need to cycle the pump and provide a fluid reservoir to maintain fluid flow. An added advantage is that flow dividers can be used to reduce the pressure between the outlet of chemical supply 10 and the inlets of mix heads 50 so that the pressure drop across each mix head 50 is below a predetermined maximum level.

For example, certain blowing agents are gases under ambient conditions. These are stored at greater than atmospheric pressure prior to use. As mentioned above, the blowing agent is typically dissolved in one of the liquid components of the resin blend. The pressure downstream of the pump in chemical supply 10 may be from 15 to 3500 psi and is preferably from 100 to 1500 psi. As pressure reducing devices, the flow dividers reduce the line pressure so that the pressure of the liquid components entering mix heads 50 is in the range of 200 to 600 psi.

If three or more chemical sources are available (other than just A and B), then there can separately be fed to their own flow dividers and split into separate streams and fed to mix heads.

While preferred embodiments of the present invention have been described herein, it will be understood that various modifications could be made without departing from the scope of the invention. For example, the number, size, and type of each piece of equipment described herein, and the manner in which they are connected and configured could be modified.

What is claimed is:

1. A system for applying a layer of foam, comprising:
a first fluid supply supplying a first stream of a first fluid in a first supply line;
a first flow divider splitting said first stream into primary and secondary streams;
a second fluid supply supplying a second fluid in a second supply line;
a second flow divider splitting said second stream into primary and secondary streams;
a first mix head combining said primary stream of said first fluid with said primary stream of said second fluid; and
a second mix head combining said secondary stream of said first fluid with said secondary stream of said second fluid.

2. The system according to claim 1 wherein the foam is a froth foam.

3. The system according to claim 1, further including at least one recycle line from at least one of said flow dividers to at least one of said fluid supplies.

4. A method for applying a layer of froth foam, comprising:
a) providing first and second fluid streams;
b) dividing each of said first and second fluid streams into a desired number of split streams; and
c) combining selected ones of said split streams so as to form a plurality of mixed streams having substantially the same composition.

5. The system according to claim 4, further including the step of recycling fluid from at least one split stream.

6. The method according to claim 4 wherein step c) includes controlling the relative volume proportions of said split streams.

7. The method according to claim 4, further including the step of providing a desired pressure drop in step b).

8. The method according to claim 4, further including the step of ejecting each of the mixed streams through a nozzle.

9. The method according to claim 8 wherein there are four mixed streams and there are four nozzles.

10. A method for applying a layer of froth foam, comprising:
a) providing first and second fluid streams;
b) dividing each of said first and second fluid streams into a desired number of split streams;
c) combining selected ones of said split stream; and
d) ejecting each of the mixed streams through a nozzle.

11. The system according to claim 10, further including the step of recycling fluid from at least one split stream.

12. The method according to claim 10, wherein step c) includes controlling the relative volume proportions of said split streams so as to form a plurality of mixed streams, each mixed stream having a desired composition.

13. The method according to claim 10, further including the step of providing a desired pressure drop in step b).

14. The method according to claim 10 wherein there are four mixed streams and there are four nozzles.
